(19) United States
(12) Patent Application Publication
(10) Pub. No.: US 2020/0150239 A1
(43) Pub. Date: May 14, 2020

(54) LIDAR SENSOR ASSEMBLY WITH OPTIC FOR LIGHT DIFFUSION AND FILTERING

(71) Applicant: Continental Automotive Systems, Inc., Auburn Hills, MI (US)

(72) Inventors: Sean H Ross, Santa Barbara, CA (US); Andrew Duerner, Goleta, CA (US); Jacob Alexander Bergam, Santa Barbara, CA (US); Bradley Short, Goleta, CA (US)

(73) Assignee: Continental Automotive Systems, Inc., Auburn Hills, MI (US)

(21) Appl. No.: 16/185,495

(22) Filed: Nov. 9, 2018

(51) Int. Cl. G01S 7/481; G01S 7/484; G01S 17/08

(52) U.S. Cl. CPC G01S 7/4814; G01S 17/08; G01S 7/484

(57) ABSTRACT

A lidar sensor assembly includes a laser light source configured to generate light. The lidar sensor assembly also includes a filter element configured to receive light from the laser light source. The filter element absorbs light at a first wavelength while allowing light at a second wavelength to pass therethrough. The lidar sensor assembly further includes a diffuser element formed integrally with the filter element and configured to scatter the light generated by the laser light source.

### TECHNICAL FIELD

The technical field relates generally to lidar sensors and more particularly to flash lidar sensors.

### BACKGROUND

Flash lidar systems often include a laser which generates multiple pulses of insense, focused light. These pulses are then diffused to spread these light pulses over a wider area. A filter element may be utilized to block undesirable wavelengths of light. Unfortunately, use of multiple elements to diffuse and filter light increases cost, complexity, size, energy use.

As such, it is desirable to present a lidar sensor assembly which does not require multiple filter and diffusion elements. In addition, other desirable features and characteristics will become apparent from the subsequent summary and detailed description, and the appended claims, taken in conjunction with the accompanying drawings and this background.

### BRIEF SUMMARY

In one exemplary embodiment, a lidar sensor assembly includes a laser light source configured to generate light. The lidar sensor assembly also includes a filter element configured to receive light from the laser light source. The filter element absorbs light at a first wavelength while allowing light at a second wavelength to pass therethrough. The lidar sensor assembly further includes a diffuser element formed integrally with the filter element and configured to scatter the light generated by the laser light source.

In one exemplary embodiment, a method of forming a optic for a lidar sensor assembly includes providing a filter element configured to receive light from a laser light source. The filter element absorbs light at a first wavelength while allowing light at a second wavelength to pass therethrough. The method also includes forming a diffuser element integrally with the filter element and configured to scatter the light generated by the laser light source.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is a perspective view of a lidar sensor assembly according to one exemplary embodiment;

FIG. 2 is cross-sectional side view of an optic of the lidar sensor assembly according to one exemplary embodiment;

FIG. 3 is a cross-sectional side view of the optic of the lidar sensor assembly according to another exemplary embodiment; and

FIG. 4 is a flowchart of a method of forming the optic according to one exemplary embodiment.

### DETAILED DESCRIPTION

Referring to the Figures, wherein like numerals indicate like parts throughout the several views, a lidar sensor assembly 100 is shown and described herein.

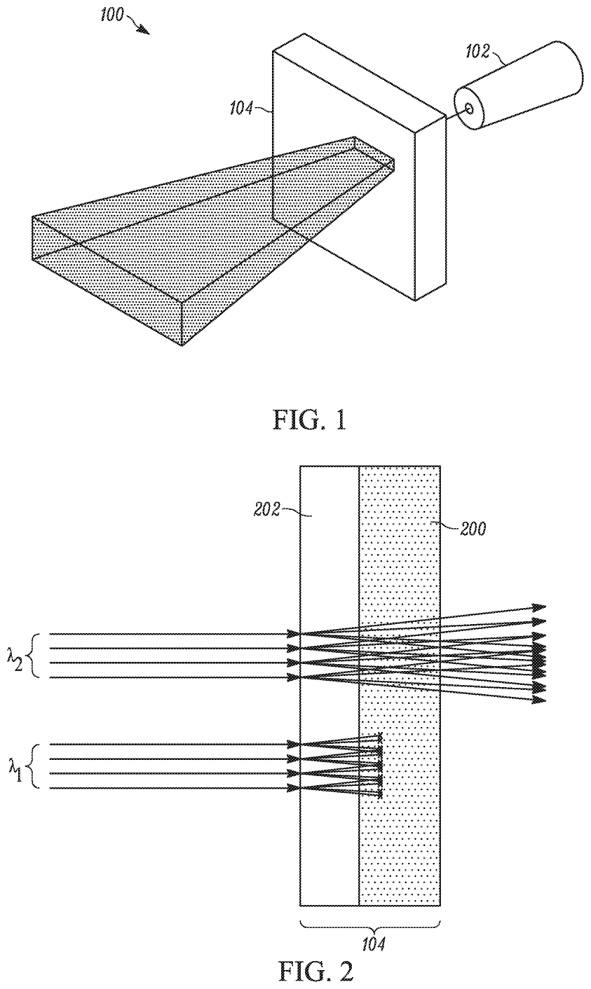

Referring to FIG. 1, the lidar sensor assembly 100, also referred to simply as the assembly 100, includes a laser light source 102 configured to generate light. The laser light source 102 may generate light at one or more wavelengths, e.g., at a first wavelength λ₁ and a second wavelength λ₂. In the exemplary embodiment, the laser light source 102 is a Nd:YAG laser system which generates light at a first wavelength λ₁ of about 808 nanometers (“nm”) and at a second wavelength λ₂ of about 1064 nm. Due to component protection and safety concerns, it is desirable to filter, i.e., block, light at the first wavelength λ₁. It should be appreciated, however, that in other embodiments, the laser light source 102 may generate light at other wavelengths besides and/or in addition to the particular wavelengths described above.

The lidar sensor assembly 100 includes an optic 104 configured to filter and scatter light of certain wavelengths. Said another way, the optic 104 transmits and scatters light at one wavelength and blocks, i.e., absorbs, light at another wavelength.

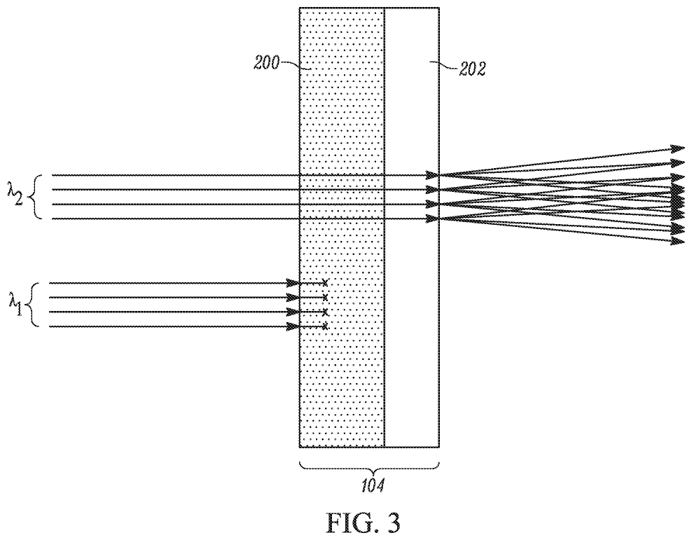

Referring now to FIGS. 2 and 3, the optic 104 includes a filter element 200. The filter element 200 is configured to receive light from the laser light source 102. The filter element 200 absorbs light at the first wavelength λ₁. That is, the filter element 200 blocks light oscillating at the first wavelength λ₁ from passing through. However, the filter element 200 allows light at a second wavelength λ₂, which is different from the first wavelength λ₁, to pass through. The filter element 200 may be made of glass, plastic, and/or any other suitable material, as appreciated by those skilled in the art.

In the exemplary embodiment, the filter element 200 may be implemented using the model No. RG850 filter manufactured by SCHOTT AG, headquartered in Mainz, Germany. This filter generally blocks wavelengths of light under 830 nm. However, it should be appreciated that other filters may be implemented as the filter element 200.

The optic 104 also includes a diffuser element 202. The diffuser element 202 is configured to scatter the light generated by the laser light source 102. That is, the diffuser element 202 disperses the focused light into a wider field-of-view. In the exemplary embodiment shown in FIG. 1, the light is dispersed into a generally rectangular field-of-view.

Referring again to FIGS. 2 and 3, the diffuser element 202 is integrally formed with the filter element 200. In one exemplary embodiment, the diffuser element 202 is refractive. As such, the direction of light wave propagation is changed due to a change in the transmission medium.

This diffuser element 202 may be formed by stamping small-feature, three-dimensional patterns on the filter element 200 That is, in one exemplary embodiment, the filter element 200 is pressed against a stamping mold (not shown) to generate the patterns of the diffuser element 202. For example, the stamped patterns may have features sized between about 1 μm and 100 μm.

In another exemplary embodiment, the refractive diffuser element is generated by the patterns being deposited on the filter element 202. In yet another exemplary embodiment, the refractive diffuser element is generated by the patterns being etched on the filter element 202.

In another exemplary embodiment, the diffuser element 202 is reflective. As such, the direction of light wave propagation is changed due to the reflective nature of the patterns of the diffuser element 202. Numerous techniques may be employed to generate the reflective diffuser element 202, including, but not limited to disposition of mirror elements onto the filter element 200.

In another exemplary embodiment, the diffuser element 202 is diffractive. As such, the diffuser element 202 includes obstacles and/or apertures which result in the bending and/or spreading of the light waves. Numerous techniques may be employed to generate the diffractive diffuser element 202, including, but not limited to disposition of a film and subsequent etching of the film to generate apertures.

In the embodiment shown in FIG. 2, the diffuser element 202 is formed on the side of the filter element 200 closer to the light source 102. In the embodiment shown in FIG. 3, the diffuser element 204 is formed on the opposite side of the filter element 200 than the embodiment of FIG. 2.

The optic 104 described above has numerous advantages over the prior art. For instance, by integrally forming the diffuser element 202 with the filter element 200, the optic 104 has less material-air interfaces than the prior art. This improves energy efficiency, which means that less energy is utilized and less heat is generated. Furthermore, the optic 104 requires less anti-reflective coatings than are typically commonplace in the prior art due to less Fresnel loss. As such, overall cost and complexity of the optic 104 is reduced.

The lidar sensor assembly 100 described above is ideally suited for use in a motor vehicle (not shown), such as an automobile. However, it should be appreciated that the lidar sensor assembly 100 and/or optic 104 shown and described herein may be utilized in many other non-vehicular applications.

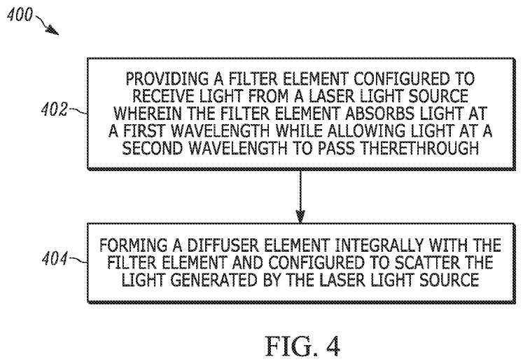

One exemplary embodiment of a method 400 of forming the optic 104 for the lidar sensor assembly 100 is shown in FIG. 4. The method 400 includes, at 402, providing a filter element configured to receive light from a laser light source wherein the filter element absorbs light at a first wavelength while allowing light at a second wavelength to pass therethrough. The method 400 also includes, at 404, forming a diffuser element integrally with the filter element and configured to scatter the light generated by the laser light source.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A lidar sensor assembly comprising:
a laser light source configured to generate light;
a filter element configured to receive light from said laser light source wherein said filter element absorbs light at a first wavelength while allowing light at a second wavelength to pass therethrough; and
a diffuser element formed integrally with said filter element and configured to scatter the light generated by said laser light source.

2. The lidar sensor assembly as set forth in claim 1 wherein said diffuser element is refractive.

3. The lidar sensor assembly as set forth in claim 2 wherein said diffuser element is formed of small-feature, three-dimensional patterns of a transparent material.

4. The lidar sensor assembly as set forth in claim 3 wherein said patterns are stamped on said filter element.

5. The lidar sensor assembly as set forth in claim 3 wherein said patterns are deposited on said filter element.

6. The lidar sensor assembly as set forth in claim 3 wherein said patterns are etched on said filter element.

7. The lidar sensor assembly as set forth in claim 1 wherein said diffuser element is reflective.

8. The lidar sensor assembly as set forth in claim 1 wherein said diffuser element is diffractive.

9. A method of forming a optic for a lidar sensor assembly, comprising:
providing a filter element configured to receive light from a laser light source wherein the filter element absorbs light at a first wavelength while allowing light at a second wavelength to pass therethrough; and
forming a diffuser element integrally with the filter element and configured to scatter the light generated by the laser light source.

10. The method as set forth in claim 9 wherein forming the diffuser element comprises stamping small-feature, three-dimensional patterns of a transparent material on the filter element such that the diffuser element is refractive.
